(19) United States
(12) Patent Application Publication
(10) Pub. No.: US 2026/0320933 A1
(43) Pub. Date: Oct. 15, 2026

(54) VISION-BASED AUGMENTED REALITY SCANNING OF ITEMS

(71) Applicant: DoorDash, Inc., San Francisco, CA (US)

(72) Inventors: Weiyu Zhou, Bellevue, WA (US); Albert Huang, Seattle, WA (US); Sihun Sung, Toronto, CA (US)

(73) Assignee: DoorDash, Inc., San Francisco, CA (US)

(21) Appl. No.: 19/643,616

(22) Filed: Apr. 9, 2026

Related U.S. Application Data
(60) Provisional application No. 63/786,855, filed on Apr. 10, 2025.

(51) Int. Cl. G06T 19/00; G06F 3/04815; G06Q 10/087; G06V 20/20; G06V 20/70

(52) U.S. Cl. CPC G06T 19/006; G06F 3/04815; G06Q 10/0877; G06V 20/20; G06V 20/70

(57) ABSTRACT

A device can display a prompt to capture an image sequence, which can include a plurality of images, of a shelf unit with items and item tags comprising machine readable codes adjacent to the items. The device can generate a first user interface visualization that indicates first scanning instructions for a first image based on a previous image of the image sequence. The device can display the first user interface visualization and the first image. The device can generate a second user interface visualization that indicates second scanning instructions. The device can display the second user interface visualization.

### CROSS-REFERENCES TO RELATED APPLICATIONS

This application claims the benefit of U.S. Provisional Application No. 63/786,855, filed on Apr. 10, 2025, which is herein incorporated by reference in its entirety for all purposes.

### BRIEF SUMMARY

One embodiment is related to a method comprising: displaying, by a user device, a prompt to capture an image sequence of a shelf unit with items and item tags comprising machine readable codes adjacent to the items, wherein the image sequence includes a plurality of images; capturing, by the user device, a first image using a camera in the user device; generating, by the user device, a first user interface visualization that indicates first scanning instructions for the first image of the image sequence based on a previous image of the image sequence, the scanning instructions for the first image being instructions to move the user device to take a second image of the image sequence; displaying, by the user device, the first user interface visualization and the first image; capturing, by the user device, the second image; generating, by the user device, a second user interface visualization that indicates second scanning instructions for the second image, the scanning instructions for the second image being instructions to move the user device to take a third image of the image sequence; and displaying, by the user device, the second user interface visualization and the second image.

Another embodiment is related to a user device comprising: a processor; and a computer-readable medium coupled to the processor, the computer-readable medium comprising code, executable by the processor, for implementing the above method.

Another embodiment is related to a method comprising: receiving, by a server computer from a user device, an inventory update message from a user device, wherein the inventory update message comprises one or more item identifiers, wherein the one or more item identifiers are determined by the user device from one or more images captured by the user device using one or more user interface visualizations to aid in image capture; determining, by the server computer from a database, item data each item identifier of the one or more item identifiers to obtain one or more item data; and updating, by the server computer, the one or more item data in an item database.

Further details regarding embodiments of the disclosure can be found in the Detailed Description and the Figures.

### BRIEF DESCRIPTION OF THE DRAWINGS

FIG. 1 shows a block diagram illustrating an analysis system according to embodiments.

FIG. 2 shows a block diagram illustrating components of a user device according to embodiments.

FIG. 3 shows a flowchart illustrating a vision based AR scanning process according to embodiments.

FIG. 4 shows a user interface illustrating user interface visualizations displayed on a user device according to embodiments.

FIG. 5 shows a block diagram illustrating a processing framework according to embodiments.

FIG. 6 illustrates the geometric principles underlying a homographic transformation in an image processing system according to embodiments.

FIG. 7 shows a diagram illustrating keyframes according to embodiments.

FIG. 8 shows a flowchart illustrating an inventory update method according to embodiments.

FIG. 9 shows a block diagram illustrating a fulfilment system according to embodiments of the disclosure.

FIG. 10 shows a flowchart illustrating a fulfilment process according to embodiments of the disclosure.

### DETAILED DESCRIPTION

Prior to discussing embodiments of the disclosure, some terms can be described in further detail.

A “user” may include an individual or a computational device. In some embodiments, a user may be associated with one or more personal accounts and/or mobile devices. In some embodiments, the user may be a cardholder, account holder, or consumer.

A “user device” may be any suitable electronic device that can process and communicate information to other electronic devices. The user device may include a processor and a computer-readable medium coupled to the processor, the computer-readable medium comprising code, executable by the processor. The user device may also include an external communication interface for communicating with each other and other entities. Examples of user devices may include a mobile device (e.g., a mobile phone), a laptop or desktop computer, a wearable device (e.g., smartwatch), etc.

An “item” can be an individual article or unit. Examples of items can include perishable items such as food items, beauty items (e.g., cosmetics), office supply products (e.g., staples, paper, and ink), hardware items (e.g., nails, hammers, wrenches), electronic devices (e.g., computers, phones, etc.), jewelry, etc.

A “transporter” can be an entity that transports something. A transporter can be a person that transports an item using a transportation device (e.g., a car). In other embodiments, a transporter can be a transportation device that may or may not be operated by a human. Examples of transportation devices include cars, boats, scooters, bicycles, drones, airplanes, etc. In some embodiments, the user device can be integrated into a transportation device. A transporter can be an autonomous vehicle such as an autonomous car or autonomous drone.

A “fulfillment request” can be a request to provide a resource in response to a request. For example, a fulfillment request can include an initial communication from an end user device to a central server computer for a first service provider computer to fulfill a purchase request for a resource such as food. A fulfillment request can be in an initial state, a completed state, or a final state. A fulfillment request can include one or more selected items that a user wishes to obtain from a selected service provider.

A “delivery order” can include a request to deliver one or more items. Delivery orders can include requests to provide one or more items from a pickup location to a drop-off location. Delivery orders can include orders to deliver items from service provider locations to end user locations. Delivery orders can include orders to deliver items from end user locations to service provider locations. An example of this type of delivery order can be a return order (e.g., to deliver an item that is to be returned). A delivery order can include data to fulfill the delivery request including an order type, an indication of an item, a pickup location, and a drop-off location. In some embodiments, the delivery order can include a scheduling range by which the order is to be fulfilled. A delivery order can also include metadata. The metadata can include data relating to the delivery order (e.g., related order numbers, instruction data, etc.).

A “route” can include a way or course taken in getting from a starting point to a destination. For example, a route can indicate a path that can be followed to move from a pickup location to a drop-off location. In some embodiments, a route can indicate a suggested path that a transporter can follow to deliver an item from a service provider to an end user (or vice-versa) for a delivery order. A route can be a journey between two locations.

“Image data” can include information related to a visible impression obtained by a camera, telescope, microscope, or other device, or displayed on a computer or video screen. Image data can include a plurality of pixels, where each pixel can include data that indicates how that pixel is displayed (e.g., a color value, etc.).

An “image sequence” can include a plurality of images that are captured in succession. An image sequence can be captured by a camera of a user device during a scanning or data capture operation. An image sequence can be captured in response to user actions or can be automatically captured by the user device according to scanning instructions or operational criteria. Each image in the image sequence can include image data (e.g., pixel related data such as color), metadata (e.g., a timestamp, device orientation, or a transform matrix), and visual information relevant to the operational process. In some embodiments, an image sequence can be analyzed to detect, compare, and track items, item tags, or barcodes across the captured images. An image sequence can be used to generate user interface visualizations that provide feedback or instructions to a user during a scanning workflow. In some embodiments, an image sequence can be a video when displayed at a suitable frames per second.

A “shelf unit” can include a surfaces upon which items can be displayed. A shelf unit can include horizontal shelves, gondola shelves, wire rack shelves, etc. A shelf unit can display a plurality of items and item tags that relate to the items.

An “item tag” can include a label that includes information about an item. An item tag can include a machine readable code (e.g., a barcode, a QR code, etc.), a price, SKU codes, and/or other information that describes the related item.

A “barcode” can include a machine-readable code that includes a plurality of bars. A barcode can be in the form of numbers and a pattern of parallel lines of varying widths (e.g., bars). A barcode can correspond to and identify a specific item.

A “user interface visualization” can include one or more graphical, textual, symbolic, or color-coded elements that are displayed on a screen. A user interface visualization can be displayed on a user device. The user interface visualization can provide a user with information, feedback, or instructions relating to an operational process. A user interface visualization can indicate scanning instructions, progress, or status during an image capture sequence. A user interface visualization can include overlays, highlights, icons, progress indicators, prompts, or other visual cues that relate to items, item tags, barcodes, or other features detected in image data. In some embodiments, a user interface visualization can update in real time or near real time (e.g., every 10 frames displayed on a screen, every 0.5 seconds, etc.) in response to processing results, user actions, or changes in device orientation. A user interface visualization can include metadata, such as color codes to indicate a processing state or completion status for particular item tags or regions within an image.

A “machine learning model” (ML model) can refer to a software module configured to be run on one or more processors to provide a classification or numerical value of a property of one or more samples. An ML model can include various parameters (e.g., for coefficients, weights, thresholds, functional properties of function, such as activation functions). As examples, an ML model can include at least 10, 100, 1,000, 5,000, 10,000, 50,000, 100,000, or one million parameters. An ML model can be generated using sample data (e.g., training samples) to make predictions on test data. Various number of training samples can be used, e.g., at least 10, 100, 1,000, 5,000, 10,000, 50,000, 100,000, or at least 200,000 training samples. One example is an unsupervised learning model such as hidden Markov model (HMM), clustering (e.g., hierarchical clustering, k-means, mixture models, model-based clustering, density-based spatial clustering of applications with noise (DBSCAN), and OPTICS algorithm), approaches for learning latent variable models such as Expectation-maximization algorithm (EM), method of moments, and blind signal separation techniques (e.g., principal component analysis, independent component analysis, non-negative matrix factorization, singular value decomposition), and anomaly detection (e.g., local outlier factor and isolation forest). Another example type of model is supervised learning that can be used with embodiments of the present disclosure. Example supervised learning models may include different approaches and algorithms including analytical learning, statistical models, artificial neural network (e.g. including convolutional and/or transformer layers) that may have 1-10 layers as examples, recurrent neural network (e.g., long short term memory, LSTM), boosting (meta-algorithm), bootstrap aggregating (bagging) such as random forests, support vector machine (SVM), support vector (SVR), Bayesian statistics, case-based reasoning, decision tree learning, inductive logic programming, linear regression, logistic regression, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), ordinal classification, data pre-processing, handling imbalanced datasets, statistical relational learning, or Proaftn (a multicriteria classification algorithm), or an ensemble of any of these types. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

A “deep neural network (DNN)” may be a neural network in which there are multiple layers between an input and an output. Each layer of the deep neural network may represent a mathematical manipulation used to turn the input into the output. In particular, a “recurrent neural network (RNN)” may be a deep neural network in which data can move forward and backward between layers of the neural network.

A “model database” may include a database that can store machine learning models. Machine learning models can be stored in a model database in a variety of forms, such as collections of parameters or other values defining the machine learning model. Models in a model database may be stored in association with keywords that communicate some aspect of the model. For example, a model used to evaluate news articles may be stored in a model database in association with the keywords “news,” “propaganda,” and “information.” A computer can access a model database and retrieve models from the model database, modify models in the model database, delete models from the model database, or add new models to the model database.

A “feature vector” may include a set of measurable properties (or “features”) that represent some object or entity. A feature vector can include collections of data represented digitally in an array or vector structure. A feature vector can also include collections of data that can be represented as a mathematical vector, on which vector operations such as the scalar product can be performed. A feature vector can be determined or generated from input data. A feature vector can be used as the input to a machine learning model, such that the machine learning model produces some output or classification. The construction of a feature vector can be accomplished in a variety of ways, based on the nature of the input data. For example, for a machine learning classifier that classifies words as correctly spelled or incorrectly spelled, a feature vector corresponding to a word such as “LOVE” could be represented as the vector (12, 15, 22, 5), corresponding to the alphabetical index of each letter in the input data word. For a more complex “input,” such as a human entity, an exemplary feature vector could include features such as the human's age, height, weight, a quantitative representation of relative happiness, etc. Feature vectors can be represented and stored electronically in a feature store. Further, a feature vector can be normalized (i.e., be made to have unit magnitude). As an example, the feature vector (12, 15, 22, 5) corresponding to “LOVE” could be normalized to approximately (0.40, 0.51, 0.74, 0.17).

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron, and/or Opteron; IBM and/or Motorola's PowerPC;
IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

### I. Introduction

Embodiments of the invention relate to digital imaging and data capture and relate to applications in inventory management, retail auditing, and order fulfillment. In such fields, it can be necessary for an operator to capture comprehensive and accurate information about a large number of items arranged on shelves, for example, in a retail store or warehouse environment.

Conventionally, this data capture process can be performed manually. An operator (e.g., a user) may utilize a handheld scanner or a camera-equipped user device to individually capture barcodes or to photograph sections of shelving. These existing methods can be inefficient and susceptible to human error. For example, users may inadvertently capture poor-quality images due to device movement or improper camera angles, which can lead to failed barcode detection. Users may also accidentally fail to capture entire sections of a shelf, such as the top shelf, resulting in an incomplete data set for an inventory or auditing task.

Furthermore, the user interfaces and methods in existing scanning applications can be unintuitive. This can make it difficult for users to perform corrective actions, such as retaking a poor-quality image, or to understand which areas of a shelf have already been successfully scanned. In the event the application crashes or the user navigates away from the scanning session, the operational context can be lost. This can force the user to restart the scanning process, potentially leading to redundant scans or missed sections. Embodiments provide technical solutions to such problems by providing for a robust, intuitive, and automated system that can guide a user to efficiently capture high-quality images of shelved items while minimizing common errors.

Conventional inventory tracking methods that rely on barcode scanning can introduce inefficiencies due to their dependency on physical labels and the need for specialized scanning devices. Such methods can be prone to errors, particularly in environments where barcode visibility can be obstructed or where label quality may have degraded over time. Further, while imaging techniques can be utilized to capture images of barcodes and items on shelf units, a user operating a device to capture the images may not have sufficient guidance on which portions of the shelf unit and which items to focus on. This can lead to the aforementioned data capture errors.

To effectively capture all items in a store, it can be advantageous to enable users to take high-quality images efficiently. It has been estimated that approximately 4-5% of undetected barcodes in images of shelf units can be due to user image capture errors. Several technical problems in current interfaces can lead to such errors. A first technical problem can be top-shelf cutoff, where users frequently fail to capture top-shelf items because a clear visual indicator of the required capture area may be absent. A second technical problem can be an unintuitive workflow, where the process for managing different image types or for retaking an image can be unclear, leading to missed shelf tags. A third technical problem can be a lack of sequential image insight, where a user cannot see the most recently captured image after an application interruption, which can lead to overlapping or missed areas in their scans. A fourth technical problem can be a lack of movement detection, where minimal feedback can be provided to a user who may be tilting or moving the device during image capture, resulting in poor image quality and subsequent barcode detection failure.

Embodiments solve such technical problems. Embodiments can provide one or more technical solutions. For example, embodiments can provide for an augmented reality (AR) scan, a 2D vision-based AR scan using homographic image transform, and image tracking. Embodiments of the disclosure solve these and other technical problems by providing for one or more technical solutions. For example, in some embodiments, a system can utilize an augmented reality (AR) scan. In other embodiments, the system can utilize a two-dimensional (2D) vision-based AR scan using a homographic image transform. In yet other embodiments, the system can utilize an image tracking solution.

For example, for the AR scan, the system can be highly accurate and can be used to map an entire store. The user experience can be highly responsive, and the system can have access to camera-to-shelf distance data and improved camera position data, which can allow for better operational guardrails. Such embodiments can also work with 3D environmental data, which can be useful for complex table layouts.

As another example, for the 2D vision-based AR scan, a homographic image transform can be utilized. A user device's vision framework can be used to help calculate a frame-to-frame transform and to track user movements. This approach can be less resource-intensive than a full AR implementation. The process can also be configured to be paused and can have a recovery mechanism for instances where tracking may be lost. This method can also allow a computer system to obtain relative spatial relationships between captured images.

As another example, for the image tracking solution, the system can use image tracking algorithms to keep track of products within a given image frame. This approach can also be less resource-intensive and can be comparatively easy to implement on a wide variety of device types and operating systems.

### II. Exemplary Scanning and Image Utilization Systems

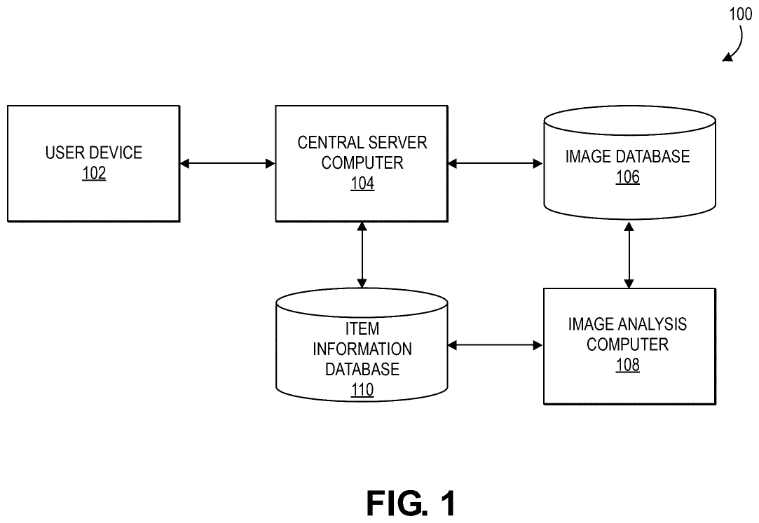

FIG. 1 shows an analysis system 100 according to embodiments of the disclosure. The analysis system 100 comprises a central server computer 102, a user device 104, an image database 106, an image analysis computer 108, and an item information database 110.

The user device 104 can be in operative communication with the central server computer 102. The central server computer 102 can be in operative communication with the image database 106 and the item information database 110. The image analysis computer 108 can be in operative communication with the image database 106 and the item information database 110.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1.

The user device 104 can include an end user device or a transporter user device operated by a user, or some other device such as a client device operated by an entity such as a resource provider, inventor manager, etc. The user device 104 can include a device such as a smartphone, a wearable device, a laptop computer, etc. The user device 104 can include a camera that can capture image data of an image. The user device 104 can provide image data for one or more images to the central server computer 102.

In some embodiments, the user device 104 can be operated by a transporter during a fulfilment request (e.g., a delivery) of an item from a service provider location to an end user, or at some other time. The transporter can be prompted by the user device 104 to capture image data using the user device 104 of a shelf unit at the service provider location. The user device 104 can include a camera capable of capturing image data. After obtaining the image data, the user device 104 can provide the image data to the central server computer 102. The user device 104 can also provide additional data related to the image data to the central server computer 102. For example, the user device 104 can provide a service provider location, a service provider identifier, a service provider location identifier, an aisle number, user device orientation data, image metadata, and/or other data related to the service provider location, shelf unit(s), and/or user device 104. The user device 104 can capture image data and/or video data by prompting the user of the user device 104 to operate the user device 104 in a particular manner using augmented reality (AR) visuals on the user device 104.

In some embodiments, the analysis system 100 can include a plurality of user devices that are in communication with the central server computer 102. Each user device of the plurality of user devices can provide additional image data to the central server computer 102.

The central server computer 102 can include a server computer that can communicate with a plurality of user devices to obtain image data and aid in processing fulfillment requests to provide resources from service providers to end users via transporters. The central server computer 102 can store received image data into the image database 106.

The central server computer 102 can maintain and update item listings that can be accessible on a delivery application managed by the central server computer 102. The delivery application can be installed on end user devices and can allow end users to select items from the item listings to have delivered to the end user from a service provider location by a transporter. The central server computer 102 can update item listings based on item information data entries in the item information database 110.

In some embodiments, the central server computer 102 can maintain and update item listings on the delivery application using data from the item information database 110 as well as inventory information provided from the service provider computer 122.

The image database 106 can store image data. The image database 106 can store information that relates the image data other data. For example, the image database 106 can store the image data in association with the service provider location, the service provider identifier, the service provider location identifier, the aisle number, user device orientation data, the image metadata, and/or other data.

The image analysis computer 108 can include computer that is configured to process image data. The image analysis computer 108 can be a laptop computer, a desktop computer, a server computer, etc. The image analysis computer 108 can obtain image data from the image database 106. The image analysis computer 108 can receive image data of an image of a shelf unit with items and item tags. The image analysis computer 108 can analyze the image data. For example, the image analysis computer 108 can identify items and item tags in the image data.

In some embodiments, after processing the image data, the image analysis computer 108 can generate an item information data entry that indicates information about one or more items identified in the image data. The image analysis computer 108 can store the item information data entry into the item information database 110.

The item information database 110 can store item information data entries for items that are provided by service providers to end users via transporters. The item information database 110 can store information that can indicate that a particular item is in stock, missing, removed from the shelf unit, moved, etc. The item information database 110 can store item identifiers (e.g., item name, item number, etc.) along with an indication of whether or not an item was removed.

The image database 106 and the item information database 110 can include any suitable databases. The databases may be a conventional, fault tolerant, relational, scalable, secure database such as those commercially available from Oracle™ or Sybase™.

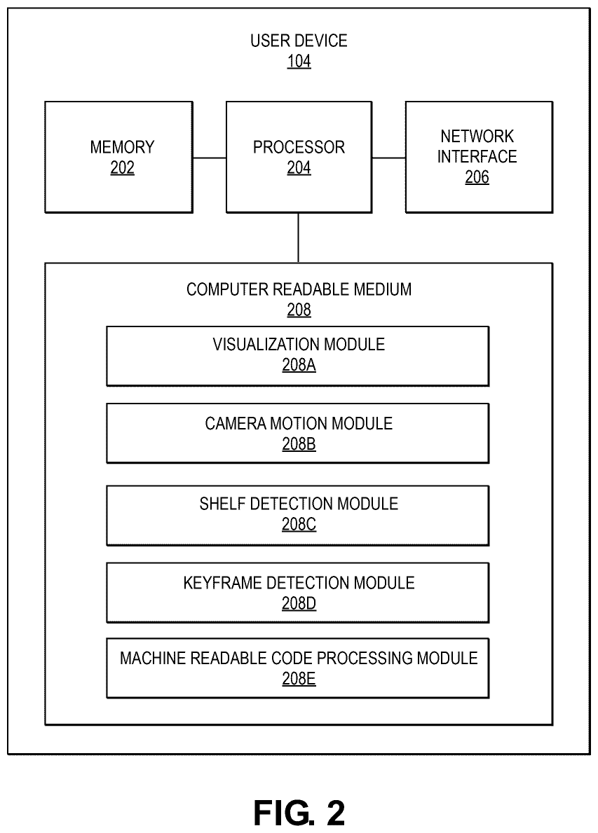

FIG. 2 shows a block diagram of the user device 104 according to embodiments. The exemplary user device 104 may comprise a processor 204. The processor 204 may be coupled to a memory 202, a network interface 206, and a computer readable medium 208. The computer readable medium 208 can comprise a visualization module 208A, a camera motion module 208B, a shelf tag detection module 208C, a keyframe detection module 208D, and a machine readable code processing module 208E.

The memory 202 can be used to store data and code. For example, the memory 202 can store image data, user interface information, user device orientation, shelf tag data, machine readable code (e.g., barcode) data, item data, service provider location related data, keyframe data, etc. The memory 202 may be coupled to the processor 204 internally or externally (e.g., cloud based data storage), and may comprise any combination of volatile and/or non-volatile memory, such as RAM, DRAM, ROM, flash, or any other suitable memory device.

The computer readable medium 208 may comprise code, executable by the processor 204, for performing a method comprising: displaying, by a user device, a prompt to capture an image sequence of a shelf unit with items and item tags comprising machine readable codes adjacent to the items, wherein the image sequence includes a plurality of images; capturing, by the user device, a first image using a camera in the user device; generating, by the user device, a first user interface visualization that indicates first scanning instructions for the first image of the image sequence based on a previous image of the image sequence, the scanning instructions for the first image being instructions to move the user device to take a second image of the image sequence; displaying, by the user device, the first user interface visualization and the first image; capturing, by the user device, the second image; generating, by the user device, a second user interface visualization that indicates second scanning instructions for the second image, the scanning instructions for the second image being instructions to move the user device to take a third image of the image sequence; and displaying, by the user device, the second user interface visualization and the second image.

The visualization module 208A may comprise code or software, executable by the processor 204, for generating user interface visualizations. The visualization module 208A, in conjunction with the processor 204, can generate, update, and render graphical overlays, prompts, and other visual cues on a display of the user device 104 in real time or near real time. These user interface visualizations can provide scanning instructions, highlight detected item tags, indicate areas of the shelf unit that require additional image capture, and visually distinguish between processed and unprocessed regions within an image sequence. The visualization module 208A, in conjunction with the processor 204, can compute and display dynamic visual feedback, including color-coded indicators reflecting the processing status of item tags, spatial relationships between images using transforms, and interactive guidance to assist a user in achieving complete coverage of a shelf unit during a scanning operation. In some embodiments, the visualization module 208A, in conjunction with the processor 204, can integrate metadata such as timestamps, device orientation, or transform matrices into the user interface.

The camera motion module 208B may comprise code or software, executable by the processor 204, for detecting and tracking camera motion. The camera motion module 208B, in conjunction with the processor 204, can continuously monitor and analyze sensor data from the user device 104, such as accelerometer and gyroscope readings, to determine the current orientation (e.g., including a pitch, a yaw, and a roll) and movement of the camera. The camera motion module 208B, in conjunction with the processor 204, can detect changes in the stability of the user device 104, identify when the camera is steady or in motion, and emit events or signals to other modules indicating periods of optimal stability for image capture. The camera motion module 208B, in conjunction with the processor 204, can provide real-time feedback or warnings to the user if undesirable motion is detected during an image capture sequence, such as excessive tilt or shake, thereby helping to reduce the likelihood of capturing low-quality or blurred images. In some embodiments, the camera motion module 208B, in conjunction with the processor 204, can trigger automatic image capture when the device orientation and motion meet predefined criteria for stability.

The shelf tag detection module 208C may comprise code or software, executable by the processor 204, for detecting shelf tags in an image. The shelf tag detection module 208C, in conjunction with the processor 204, can apply image analysis processes, including machine learning models, to each image in an image sequence (or a subset thereof) to identify regions corresponding to item tags and machine readable codes affixed to shelf units. The shelf tag detection module 208C, in conjunction with the processor 204, can extract, localize, and classify detected shelf tags. The shelf tag detection module 208C, in conjunction with the processor 204, can assign unique identifiers to each evaluated machine readable code. The shelf tag detection module 208C, in conjunction with the processor 204, can determine a confidence level for each detection. The shelf tag detection module 208C, in conjunction with the processor 204, can further compare detected shelf tags in a current image to those in previous image(s), merging results for tags detected in the same location. The shelf tag detection module 208C, in conjunction with the processor 204, can provide data to the visualization module 208A for display. The shelf tag detection module 208C, in conjunction with the processor 204, can also support real-time or batch processing modes, depending on system resource constraints and operational requirements.

The keyframe detection module 208D may comprise code or software, executable by the processor 204, for determining keyframes. The keyframe detection module 208D, in conjunction with the processor 204, can analyze a sequence of captured images and associated metadata to identify optimal moments for capturing high-resolution keyframe images. The keyframe detection module 208D, in conjunction with the processor 204, can make such a determination based on criteria such as the detection of a threshold number of new item tags, a steady state of the user device 104 as reported by the camera motion module 208B, or the need to capture higher quality image data for downstream processing. Upon meeting such criteria, the keyframe detection module 208D, in conjunction with the processor 204, can trigger the user device 104 to capture a high-resolution image (e.g., a keyframe) and store associated metadata, such as transform matrices, timestamps and orientation data. The keyframe detection module 208D, in conjunction with the processor 204, can manage a queue of pending keyframes for further processing, such as barcode decoding or additional image analysis.

The machine readable code processing module 208E may comprise code or software, executable by the processor 204, for processing machine readable codes. The machine readable code processing module 208E, in conjunction with the processor 204, can receive high-resolution keyframe images captured by the user device 104. The machine readable code processing module 208E, in conjunction with the processor 204, can perform the extraction, decoding, and verification of machine readable codes, such as barcodes or QR codes, which are associated with item tags detected in the analyzed images. The machine readable code processing module 208E, in conjunction with the processor 204, can utilize decoding methods, error correction routines, and confidence scoring techniques to maximize the accuracy and reliability of machine readable code recognition. The machine readable code processing module 208E, in conjunction with the processor 204, can operate in a background or lower-priority thread to minimize impact on real-time user interface responsiveness. Results generated by the machine readable code processing module 208E can be integrated with item tag data and provided to other system components for further processing, such as inventory updates, order fulfillment, or audit reporting.

The network interface 206 may include an interface that can allow the user device 104 to communicate with external computers. The network interface 206 may enable the user device 104 to communicate data to and from another device (e.g., the central server computer 102, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

### III. Vision-Based AR Scanning

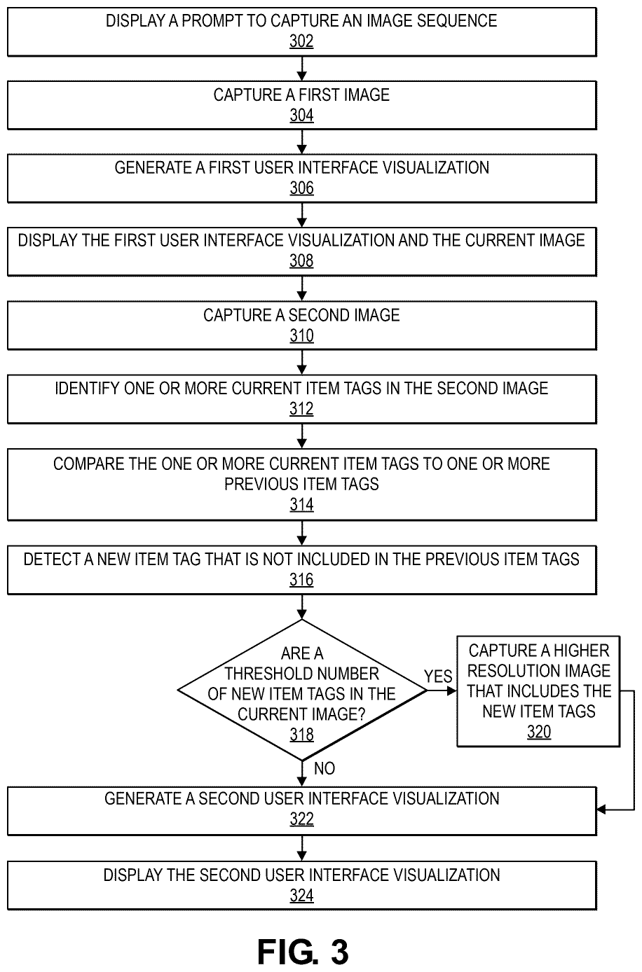

Embodiments provide for systems, methods, and apparatuses for vision-based augmented reality scanning. The scanning process can be implemented on a user device and can utilize a multi-queue processing framework to manage different computational tasks in parallel, thereby providing a responsive and accurate scanning experience for a user. Embodiments can allow the user device to provide real-time visual guidance, automatically capture high-quality images, detect and track item tags across a sequence of images, and process machine readable codes with high efficiency. Methods, user interfaces, system architectures, and underlying technical principles of the vision-based AR scanning process will be described in further detail with reference to FIGS. 3-7.

### A. Overview

FIG. 3 shows a flowchart illustrating a vision-based AR scanning process according to embodiments. FIG. 3 will be described in the context of a user utilizing a user device to scan items on a shelf unit at a service provider location (e.g., a store). The method described in reference to FIG. 3 can be performed by a user device.

At step 302, the user device can display a prompt to capture an image sequence. The user device can display the prompt on a screen or other display element of the user device to a user. The user device can display a prompt to capture an image sequence of a shelf unit with items and item tags comprising machine readable codes adjacent to the items. The image sequence can include a plurality of images. The prompt can be an indication of what to capture with the camera of the user device. The prompt can be dynamically generated, providing specific guidance based on the user's current location, device orientation, and operational context. The prompt can indicate which areas of the shelf unit have not yet been captured, highlight regions requiring additional attention, and can be updated in real time as the scanning sequence progresses.

At step 304, the user device can capture a first image. The user device can utilize a camera module to obtain a digital image of the shelf unit, including items and adjacent item tags. The image capture process can be triggered either manually by the user or automatically by the user device when optimal conditions are detected, such as user device stability or proper orientation. The user device can store image data along with associated metadata, including a timestamp, user device orientation, and transform matrix, to facilitate subsequent analysis and tracking.

At step 306, after capturing the first image, the user device can generate a first user interface visualization. The user device can generate a first user interface visualization that indicates scanning instructions for a current image (e.g., the first image) of the image sequence. The scanning instructions for the first image, for example, can be instructions to move the user device to a specific orientation in three-dimensional space to capture the next image (e.g., a second image). The first user interface visualization can be generated based on spatial relationships between the current and previous images using transforms, such as affine or homographic transforms. The first user interface visualization can include overlays, highlights, icons, or color-coded indicators that guide the user to ensure complete coverage and proper image capture. The first user interface visualization can further display progress indicators, areas requiring retake, and feedback regarding user device orientation and stability.

At step 308, the user device can display the first user interface visualization and the current image. For example, the user device can display the first user interface visualization over the current image on the screen to the user. The first user interface visualization can provide real-time feedback, such as highlighting detected item tags, marking regions that have not been scanned, and indicating the processing status of each detected item tag. The first user interface visualization can be responsive to user actions and system events, updating as new images are captured or as scanning instructions evolve. As noted above, the scanning instructions for the first image, for example, can be instructions to move the user device to a specific orientation in three-dimensional space to capture the next image (e.g., a second image). The user can then move the user device according to the scanning instructions provided by the first user interface visualization.

At step 310, the user device can capture a second image (e.g., a current image). The user device may have been moved through three-dimensional space by the user between capturing the first image and capturing the second image. The second image differ from the first image, but may overlap with the content of the first image.

At step 312, the user device can identify one or more current item tags in the current image. The user device can apply image analysis methods, including machine learning models such as YOLO or Faster RCNN, to detect item tags that include machine readable codes affixed to the shelf unit. The user device can determine a location of each item tag in the current image. The user device can also determine a confidence score using the machine learning model that is trained to identify item tags. The confidence score can indicate an accuracy of item tag detection (e.g., on a scale from 0 to 100). The user device can assign a unique identifier to each detected item tag.

At step 314, after identifying the one or more current item tags in the current image, the user device can compare the one or more current item tags to one or more previous item tags from one or more previous images of the image sequence. The comparison can involve matching identifiers, locations, and metadata to determine which item tags have already been scanned and which are new. The user device can utilize multi-object tracking (MOT) techniques, such as SORT, DeepSort, StrongSort, or ByteTrack, to maintain continuity of tracking and to associate item tag identifiers across the sequence of images.

At step 316, the user device can detect a new item tag in the one or more current item tags that is not included in the one or more previous item tags. The user device can analyze the comparison results to identify item tags that have not been previously scanned. Detection of new item tags can trigger further actions, such as updating the visualization to prompt the user to focus on newly detected areas or preparing for a higher resolution image capture if threshold criteria are met.

At step 318, the user device can determine whether or not a threshold number (e.g., 1, 2, 4, 6, etc.) of new item tags are in the current image. This determination can be based on predefined or dynamic thresholds.

If there the number of new item tags exceeds the threshold number, then the user device can proceed to step 320. If the number of new item tags does not exceed the threshold number, then the user device can proceed to step 32.

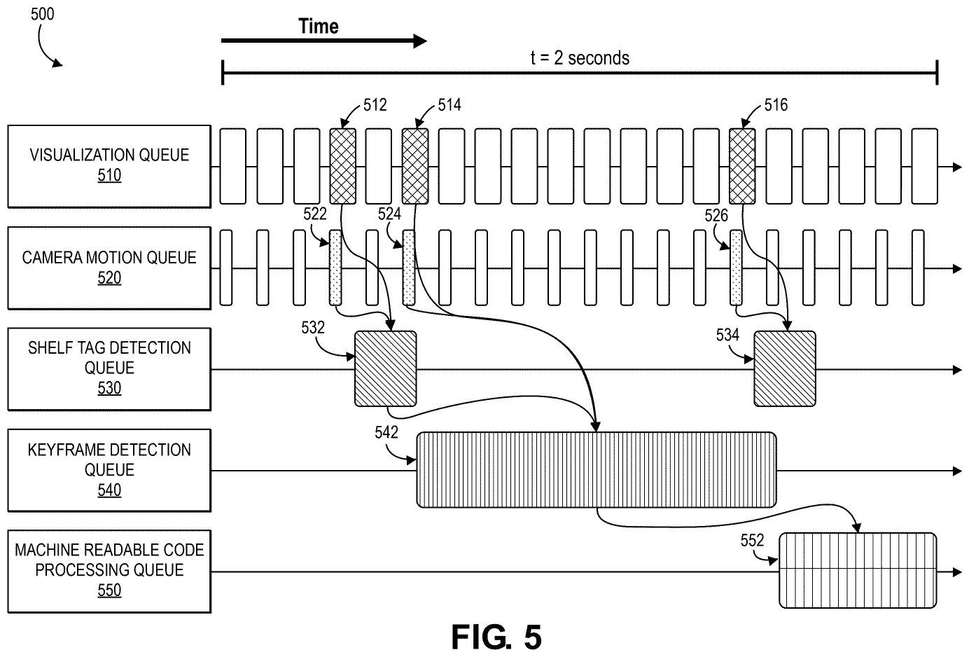

At step 320, after determining that the number of new item tags exceeds the threshold number, the user device can capture a higher resolution image (e.g., a keyframe) that includes the new item tags. The user device can capture a high-resolution image. By capturing a high-resolution image, the user device can ensure that the image data is suitable for detailed analysis, such as barcode decoding and optical character recognition. The user device can store metadata for the high-resolution image. The metadata can include data such as transform matrices, timestamps, and device orientation. The user device can queue the captured keyframe for further analysis by the machine readable code processing module, which can operate in a background thread to minimize impact on user interface responsiveness as described in further detail in reference to FIG. 5. For example, the user device can utilize the high-resolution image to identify machine readable codes on the shelf unit in the high-resolution image. The user device can determine a user identifier from each machine readable code in the high-resolution image.

At step 322, the user device can generate a second user interface visualization. The user device can generate the second user interface visualization that indicates scanning instructions. The scanning instructions for the second image can include instructions to move the user device in three-dimensional space to take a third image. In some embodiments, the second user interface visualization can include indications of the one or more item tags. The second user interface visualization can be updated to reflect the current scanning status, highlighting newly detected item tags, processed regions, and areas requiring retake. Color-coded labels can indicate the processing state for each item tag, and interactive prompts can guide the user to ensure comprehensive coverage and efficient scanning.

At step 324, the computer can display the second user interface visualization with the captured second image on a display of the user device to the user.

After step 324, the user device can repeatedly perform steps 302-324 as the user device is moved throughout space at a service provider location (e.g., store). For example, as the user moves the user device along a shelf unit, the user device can continuously capture images, generate visualizations, detect and track item tags, compare current and previous detections, trigger keyframe capture based on threshold criteria, and process machine readable codes in high-resolution images. The user device can maintain robust tracking of items and item tags using MOT techniques, ensuring accurate association of identifiers and seamless continuity across the image sequence. The iterative process can allow the user device to build a comprehensive and accurate data set for inventory management, auditing, or order fulfillment, while minimizing user error and maximizing operational efficiency.

### B. User Interface Visualizations

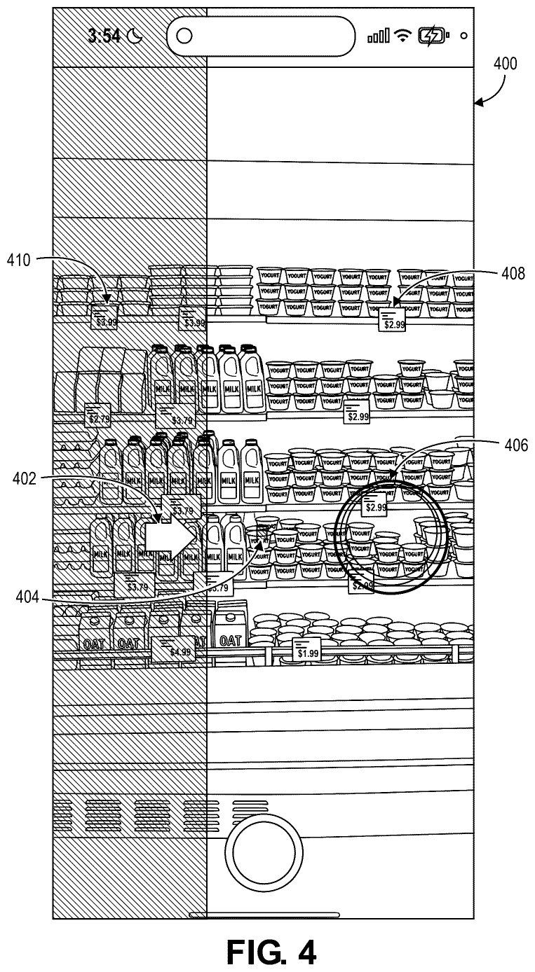

FIG. 4 shows a user interface 400 illustrating user interface visualizations displayed on a user device according to embodiments. The user interface 400 illustrates a user interface visualization and a current image. The user interface 400 shows detection results in real time and can highlight undetected shelf tags (e.g., which can effectively ask for retakes). The user interface 400 can also depict pitch, yaw, and roll tilts of the user device to the user of the user device on the screen. The user device can auto capture keyframes (e.g., high-resolution images) for further processing.

FIG. 4 depicts a user interface visualization including scan instructions overlayed on a current image such as a first image. For example, FIG. 4 includes a scan direction indicator 402, a current center point 404, a target center point 406, an unidentified item tag 408, and an identified item tag 410. In this example, the user interface visualization can include at least the scan direction indicator 402, the current center point 404, the target center point 406. These scan instructions are used to cause the user to move the user device and then take a second image according to the scan instructions.

The scan direction indicator 402 can indicate to the user in which direction to move the camera. The scan direction indicator 402 can be displayed as an arrow, line, or graphical overlay that dynamically updates based on the spatial relationship between the current image and previously captured images in the image sequence. The indicator can utilize computed transforms and device orientation data to provide precise guidance, helping the user to avoid redundant scans and to ensure comprehensive coverage of the shelf unit. In some embodiments, the scan direction indicator 402 can also account for detected gaps in the image sequence, prompting the user to move the camera toward unscanned regions or to revisit areas with insufficient image quality.

The current center point 404 can indicate to the user a current center of the captured images in the image sequence. The current center point 404 can be displayed as a graphical marker, such as a dot or crosshair, overlaid on the current image to represent the geometric center of the most recently captured image or the current center of the user's screen. The current center point 404 can be updated in real time as the user device moves, reflecting the device's position and orientation. This assists the user in maintaining alignment during scanning operations and provides a visual reference for where the device is focused relative to the shelf unit.

The target center point 406 can indicate to the user a location at which the user should position the current center point 404 to capture a next keyframe image (e.g., a high resolution image such that item tags can be identified). The target center point 406 can be displayed as a distinct graphical marker or highlight, representing the optimal position for capturing the next high-resolution keyframe. This position can be determined by the system based on the distribution of item tags, detected gaps, or areas with insufficient scan coverage. The user interface can provide interactive feedback, such as color changes or animation, to help the user align the current center point 404 with the target center point 406. When alignment is achieved and user device stability criteria are met, the user device can automatically trigger the capture of a high-resolution keyframe image.

The unidentified item tag 408 can include an item tag on the shelf unit that has be detected in the image, but has not yet been captured using a high resolution image such that the item tag is identified. The unidentified item tag 408 can be visually distinguished in the user interface, for example, by using a specific color code, border, or icon to indicate its status. The system can track unidentified item tags across the image sequence using multi-object tracking algorithms (e.g., SORT, DeepSort, ByteTrack), ensuring continuity even as the user device moves. The presence of unidentified item tags can prompt the user, via visual or textual cues, to focus on these areas and to capture additional images or keyframes, thereby enabling the user device to obtain higher quality data for downstream processing.

The identified item tag 410 can include an item tag on the shelf unit that has been detected in the image and has been captured using a high resolution image. The identified item tag 410 can be displayed in the user interface with a different visual treatment, such as a completed color code, checkmark, or another indicator, signifying that the tag has been successfully captured and processed. The user device can maintain a record of identified item tags, linking them to their associated high-resolution images and decoded machine readable codes. This allows the user to track progress in real time, ensures that all required item tags have been scanned, and facilitates efficient workflow management. The distinction between unidentified and identified item tags within the user interface visualization can support operational accuracy, reduce user errors, and optimize the scanning process.

### C. Parallel Processing Queues

FIG. 5 shows a block diagram illustrating a processing framework according to embodiments. FIG. 5 depicts a queue system 500 that allows a user device to efficiently capture and process an image sequence comprising a plurality of images. The queue system 500 includes a visualization queue 510, a camera motion queue 520, a shelf tag detection queue 530, a keyframe detection queue 540, and a machine readable code processing queue 550. Each queue can be configured with a designated processing priority and can operate either in parallel or in coordination with other queues to optimize system responsiveness and data accuracy.

Prior to performing the processing queues illustrated in FIG. 5, the user device can display a prompt to a user, requesting the user to capture an image sequence of a shelf unit containing items and item tags comprising machine readable codes adjacent to the items. The initiation prompt can be dynamically generated based on operational context, device orientation, and scanning objectives.

### 1. Visualization Queue

The visualization queue 510 can be configured to generate, update, and render user interface visualizations on the user device in real time or near real time. The visualization queue 510 can provide immediate feedback to the user, including scanning instructions, highlighting detected item tags, and indicating areas of the shelf unit that require additional image capture. User interface visualizations generated by the visualization queue 510 can reflect the current scanning status, inform the user of scanning progress, and dynamically update to guide the user toward optimal image capture.

The visualization queue 510 can operate at a high processing priority and can be executed on every frame, or every few frames, of the display to ensure a seamless and responsive user experience during scanning. A frame can be a single image or buffer captured by the user device's camera and processed at a given sampling rate. The visualization queue 510 can synchronize its update rate with the camera's frame rate, for example, executing visualization logic at 30 or 60 frames per second (fps), or at a reduced rate (e.g., 10 fps) to allocate more processing time per frame for complex computations and resource optimization.

In some embodiments, the user device can dynamically adjust the visualization queue's 510 processing rate based on system resource constraints, device capabilities, or operational requirements. For example, at a frame rate of 30 fps, each frame can be processed within approximately 30 milliseconds, ensuring that visual feedback and scanning guidance are rendered without perceptible delay. At lower frame rates, such as 10 fps, the user device can allocate more computation time per frame (e.g., 100 milliseconds), allowing for more advanced image analysis, registration, and overlay rendering.

The visualization queue 510 can include multiple visualization iterations, such as a first visualization iteration 512, a second visualization iteration 514, and a third visualization iteration 516. Each visualization iteration may occur during a different processing frame of the user device. During each iteration, the user device can generate and display a user interface visualization reflecting the current scanning status, item tag detection results, and guidance for further image capture.

During the first visualization iteration 512, the user device can compare a current camera buffer to a previous camera buffer. The user device can determine a transform between the two, where the transform can represent spatial relationships such as translation, rotation, scale, or perspective warp between consecutive images. The user device can, for example, utilize VNTranslationalImageRegistrationRequest from Apple's Vision Frameworks. The transform can be computed using various image registration methods, such as:
VNTranslationalImageRegistrationRequest (affine/linear translation),
VNHomographicImageRegistrationRequest (perspective/homography),
VNTrackTranslationalImageRegistrationRequest (stateful affine tracking), and
VNTrackHomographicImageRegistrationRequest (stateful homographic tracking).

The determined transform can allow the user device to align images, track camera movement, and maintain accurate visualization overlays. Alignment can facilitate seamless merging of scan data, robust item tag detection, and spatially consistent guidance to the user. The visualization queue 510 can employ these registration techniques to ensure that visual overlays and scanning instructions remain contextually accurate as the user moves the user device and captures new images.

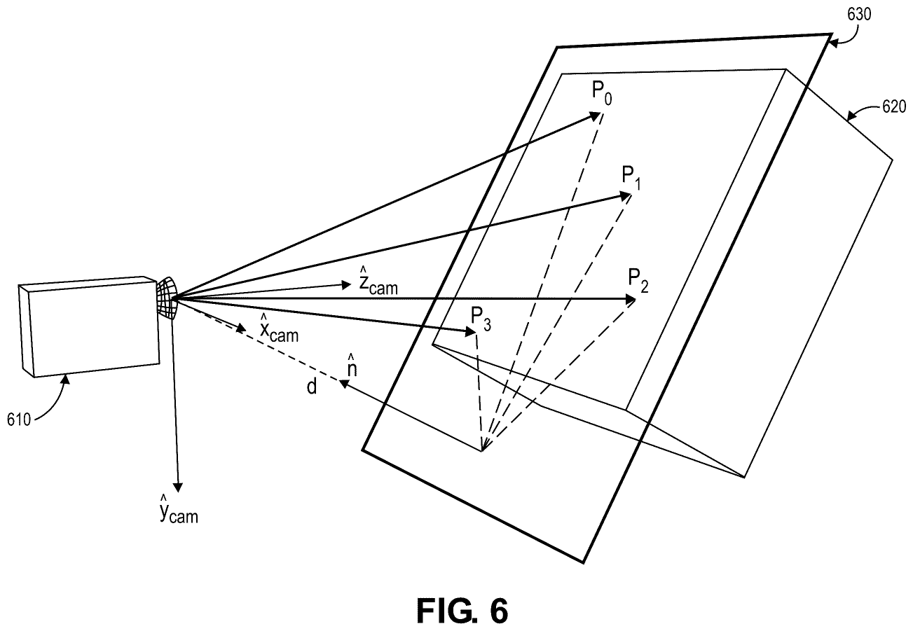

When using VNTranslationalImageRegistrationRequest, the user device can determine the affine transform necessary to align the content of two images through translation, focusing on linear shifts without distortion. This method can be suitable for aligning images with minor viewpoint changes and can be utilized for stabilizing video sequences. In contrast, VNHomographicImageRegistrationRequest can allow the user device to determine a perspective warp matrix that can align images captured from different viewpoints or under non-linear distortions. This approach can be useful for stitching panoramic images or aligning images taken from various angles. VNTrackTranslationalImageRegistrationRequest and VNTrackHomographicImageRegistrationRequest can perform similar processing but can maintain a stateful registration across consecutive frames, enhancing continuity and robustness in tracking. An example illustrating the use of homographic images is described in reference to FIG. 6, below.

In some embodiments, if the tracking between image buffers is lost (e.g., due to occlusion, abrupt movement, or interruption), the user device can compare the current image with earlier captured images to identify a possible match and recover the scanning session. The visualization queue 510 can also be responsible for displaying overlays that include recognized shelf tags, color-coded status indicators, and guidance prompts to enable efficient and accurate scanning.

The second visualization iteration 514 and the third visualization iteration 516 can be similar to the first visualization iteration 512, each incorporating updated scan data, transforms, and item tag detection results to continually refine and render user interface visualizations that optimize the scanning workflow.

### 2. Camera Motion Queue

The camera motion queue 520 can operate at medium priority and can monitor the orientation and movement of the user device and the camera in the user device. The camera motion queue 520 can operate at a rate of 10 frames per second or similar sampling frequency (e.g., 5 fps, 12 fps, 20 fps, 25 fps, etc.), balancing responsiveness and computational efficiency. By analyzing sensor data (e.g., including accelerometer data and gyroscope data) the camera motion queue 520 can track pitch, yaw, roll, acceleration, and other parameters to determine user device stability and movement patterns.

The camera motion queue 520 can include a first camera motion iteration 522, a second camera motion iteration 524, and a third camera motion iteration 526. The first camera motion iteration 522 may occur when the first visualization iteration 512 occurs (e.g., during a same frame). The second camera motion iteration 524 may occur when the second visualization iteration 514 occurs. The third camera motion iteration 526 may occur when the third visualization iteration 526 occurs.

The camera motion queue 520 can emit events that trigger keyframe capture when optimal conditions are detected, such as user device steadiness or proper alignment with the shelf unit. These events can be used to initiate shelf tag detection and high-resolution image (e.g., keyframe) capture, ensuring that keyframes are acquired only when the device is stable and the scene is optimally composed.

For example, the first camera motion iteration 522, along with the first visualization iteration 512, can trigger a first shelf tag detection iteration 532 in the shelf tag detection queue 530. As another example, the second camera motion iteration 524, along with the second visualization iteration 514, can trigger a first keyframe detection iteration 542 in the keyframe detection queue 540. As another example, the third camera motion iteration 526, along with the third visualization iteration 516, can trigger a second shelf tag detection iteration 534 in the shelf tag detection queue 530.

The camera motion queue 520 can also provide guidance to the visualization queue 510 to help users improve image quality by adjusting their movement or alignment. For example, if excessive tilt or shake is detected, the camera motion queue 520 can prompt the visualization queue 510 to display feedback or corrective instructions, encouraging the user to steady the user device or reposition the camera for optimal scanning.

In some embodiments, the camera motion queue 520 can log sensor data, timestamped orientation values, and motion events, which can be utilized for downstream analysis, session recovery, and quality assurance. By integrating real-time motion monitoring and event-driven guidance, the camera motion queue 520 can significantly enhance the accuracy and reliability of the vision-based scanning process.

### 3. Shelf Tag Detection Queue

The shelf tag detection queue 530 can detect and localize shelf tags within each current image of an image sequence acquired by the user device. This shelf tag detection queue 530 can operate at a medium processing priority and can be executed at regular intervals, such as once per second or every few seconds, to balance computational efficiency with detection accuracy. For example, the shelf tag detection queue 530 can be performed at a sampling frequency of 1 frame per second, 2 frames per second, 4 frames per second, or any other suitable interval depending on user device resources and operational requirements. In some embodiments, the shelf tag detection queue 530 may be initiated by events triggered by the visualization queue 510 and/or the camera motion queue 520.

The detection process can utilize advanced object detection models, such as a shelf tag YOLO model or other convolutional neural network-based algorithms, to identify shelf tags, item tags and machine readable codes attached to shelf units. These models can analyze the image buffer and classify specific regions as shelf tags with associated confidence scores, thereby enabling robust detection even in varied lighting or occlusion conditions.

As depicted in FIG. 5, the shelf tag detection queue 530 can include distinct detection iterations, such as a first shelf tag detection iteration 532 and a second shelf tag detection iteration 534. Each shelf tag detection iteration can correspond to the processing of a specific image frame and can result in either the identification of new shelf tags, the confirmation of previously detected tags, or the determination that no shelf tags are included in the image. This iterative operation can allow the user device to maintain an up-to-date record of detected tags as the image sequence progresses.

Following detection, the shelf tag detection queue 530 can compare newly detected shelf tags against previously identified tags from earlier images in the sequence. The comparison can be based on spatial location, tag identifiers, and associated metadata. The location of each shelf tag can be determined by combining its relative position within the captured image with a computed image transform, which aligns the current image with prior images and ensures consistent spatial mapping across the entire sequence.

If multiple detections of the same shelf tag occur at the same location or within a permissible positional threshold, the results can be merged to avoid redundant processing. Each detected shelf tag can be assigned a unique identifier and a color-coded status within the user interface visualization. The status can indicate whether the tag has been newly detected, is pending high-resolution capture, or has been confirmed and processed. This visual feedback mechanism can guide the user to focus on unscanned or newly detected areas, thereby facilitating efficient workflow management and comprehensive coverage.

While real-time object detection is achievable with modern models such as YOLO models, the user device can intentionally limit the detection process to a lower frequency, such as 1 frame per second, to conserve computational resources and allow higher-priority queues, such as the visualization queue 510, to maintain real-time responsiveness. This approach ensures that the shelf tag detection process does not adversely impact overall user experience or user device performance.

The shelf tag detection queue 530 can communicate detected tags and their respective statuses to the visualization queue 510 for real-time overlay display. Additionally, when a threshold number of new shelf tags are identified, the shelf tag detection queue 530 can communicate with the keyframe detection queue 540 to trigger high-resolution image capture.

By operating in iterative cycles and leveraging machine learning-based detection, spatial transforms, and color-coded status assignment, the shelf tag detection queue 530 can provide for robust, efficient, and accurate identification of shelf tags throughout the scanning process.

### 4. Keyframe Detection Queue

The keyframe detection queue 540 can be configured as a medium-priority processing queue within the user device. The keyframe detection queue 540 can be triggered when the user device determines that a sufficient percentage or threshold number of new shelf tags are present in the image capture area, and when the user device detects that it is steady, such as having minimal or no pitch, yaw, or roll. In some embodiments, the keyframe detection queue 540 can be triggered by or can continuously monitor data received from the shelf tag detection queue 530 and the camera motion queue 520 to assess whether the operational criteria for keyframe capture have been met.

Once the triggering conditions are satisfied, the keyframe detection queue 540 can initiate the capture of a high-resolution image, for example, a 48-megapixel (MP) photograph. Capturing a high-resolution keyframe can ensure that the resulting image data contains sufficient detail for accurate downstream analysis, including the detection and decoding of machine readable codes. The high resolution can help to minimize the risk of errors in code extraction due to low image quality or suboptimal capture conditions.

Each keyframe detection event can correspond to a specific iteration within the queue, such as the first keyframe detection iteration 542 illustrated in FIG. 5. In this iteration, the system can record relevant metadata associated with the keyframe, including the timestamp of capture, device orientation, transform matrix, and the spatial relationship of detected shelf tags within the frame. This metadata can be crucial for maintaining the continuity of the scanning session and for merging data from multiple keyframes across the image sequence.

Upon successful capture of a high-resolution keyframe, the keyframe detection queue 540 can trigger the machine readable code processing queue 550. The captured keyframe can be passed to the machine readable code processing queue 550 for further processing. This handoff between queues can be implemented as an event-driven or message-passing mechanism, ensuring seamless integration and minimal latency between high-resolution image capture and code analysis operations. For example, the first keyframe detection iteration 542 can trigger a first machine readable code processing iteration 552 in the machine readable code processing queue 550.

The keyframe detection queue 540 can also maintain a queue or log of pending and processed keyframes, enabling the user device to manage resources, prevent redundant captures, and support session recovery in the event of interruptions. By coordinating with other processing queues and leveraging both image analysis and device motion data, the keyframe detection queue 540 can optimize the timing and quality of high-resolution captures, thereby enhancing the reliability and accuracy of the overall vision-based scanning process.

### Machine-Readable Code Processing Queue

The machine readable code processing queue 550 can be configured as a low-priority processing queue within the user device, reflecting the computationally intensive nature of the tasks performed by the machine readable code processing queue 550 and the need to minimize interference with real-time user interface operations. The machine readable code processing queue 550 may only be triggered when a high-resolution keyframe image becomes available, as such images provide the necessary detail for accurate detection and decoding of machine readable codes.

Upon activation, the machine readable code processing queue 550 can receive the high-resolution keyframe and initiate an analysis by cropping the image to regions of interest that are likely to contain machine readable codes. This targeted approach can reduce computational overhead and improve the efficiency of the code detection process. The user device can employ one or more code recognition methods, which may include traditional barcode decoding routines, advanced image processing techniques, or machine learning-based models, to extract, decode, and verify the machine readable codes present in the image.

The processing tasks within the machine readable code processing queue 550 can be executed in a separate thread or as a background process. By isolating these intensive operations from the main user interface and real-time queues, the user device can ensure that user interactions remain fluid, responsive, and unaffected by periodic bursts of computational demand associated with code recognition.

Each invocation of the machine readable code processing queue 550 can correspond to a specific processing iteration, such as the first machine readable code processing iteration 552 depicted in FIG. 5, which may be directly triggered by a preceding keyframe detection iteration 542. This event-driven architecture allows the system to dynamically respond to successful high-resolution captures and begin code analysis without manual intervention.

In some embodiments, the machine readable code processing queue 550 can be configured to reconcile results from multiple processing runs to maximize accuracy and reliability. For instance, if both the current processing run and a previous run yield identical machine readable code results for a given item tag, the user device can use the machine readable code to determine an item identifier or to retrieve related item data for inventory or other purposes. In situations where multiple iterations of machine readable code determination generate differing machine readable code results, then the user device can compare confidence scores, error correction metrics, or source quality indicators and select the machine readable code with the highest confidence for further processing.

By structuring the machine readable code processing queue 550 to operate asynchronously, rely on high-resolution input, and include robust decision logic for reconciling results, the user device can achieve accurate, efficient, and reliable extraction of item-related data from complex and variable shelf environments.

### D. Homographic Transformation

FIG. 6 illustrates the geometric principles underlying a homographic transformation in an image processing system, according to embodiments. FIG. 6 includes a user device 610, which can include a camera, positioned to view a planar surface of a shelf unit 620. FIG. 6 also depicts an image plane 630. The principles of homography can be used to mathematically describe a relationship between two different images of the same planar surface. This relationship can enable functionalities such as image rectification for perspective correction, image registration for aligning or stitching images, and the estimation of camera motion, including rotation and translation, between two captured images.

A planar homography can relate the transformation between two planes, and this relationship can be defined up to a scale factor. The transformation can be represented by a homography matrix, which can be a 3×3 matrix with eight degrees of freedom. Planar homography can describe several types of transformations, including the mapping between a planar surface in three-dimensional space and a two-dimensional image plane, or the relationship between two images of a planar surface captured from two different camera positions. Planar homography can also be utilized for camera pose estimation from coplanar points, which can be a technique for augmented reality applications, or for perspective removal and correction in image analysis.

As illustrated in FIG. 6, the user device 610 can have an associated camera coordinate system defined by axes \hat{x}_{cam}, ŷ_{cam}, and \hat{z}_{cam}. The z-direction of \hat{z}_{cam} can represent the optical axis of the camera. The shelf unit 620 can be oriented such that its planar surface is tilted with respect to (e.g., relative to) the camera's coordinate system. A series of points on the planar surface, such as P₀, P₁, P₂, and P₃, can be projected onto the image plane 630 of the user device 610. The geometric properties of the image plane 630 can be described by its normal vector, \hat{n}, and a perpendicular distance d, from the camera's center of projection to the image plane 630. This geometric relationship between the user device 610 and the image plane 360 can be used to compute a homographic transformation.

As an example, to formalize the three-dimensional plane-to-plane equation, it can be assumed that a first camera view a and a second camera view b can be used to capture images of points Pᵢ on the image plane 630. FIG. 6 can be understood as illustrating the geometric setup for one of these views (e.g., camera a). The transformation that maps the projection of a point Pᵢ from the image plane 630 of camera b (denoted as ^{b}pᵢ) to the image plane of camera a (denoted as ^{a}pᵢ) can be expressed as:

$${a}^{} {p}_{i} = \frac{{b}^{} {z}_{i}}{{a}^{} {z}_{i}} {K}_{a} \cdot {H}_{ab} \cdot {K}_{b}^{- 1} \cdot {b}^{} {p}_{i}$$

Where ^{a}zᵢ and ^{b}zᵢ are the z coordinates of P in each camera frame and where the homography matrix H_{ab} is given by

$${H}_{ab} = R - \frac{{tn}^{T}}{d} .$$

R can be a rotation matrix by which camera b is rotated in relation to camera a. t can be a translation vector from camera a to camera b. n and d can respectively be the normal vector of the plane and the distance from an origin to the plane. Kₐ and K_{b} can be the cameras' intrinsic parameter matrices.

Using homographic transformation and/or other spatial image processing techniques, the user device can detect that a camera plane of a camera in the user device is parallel to a shelf unit plane. The user device can determine whether or not the camera is at an angle to the shelf unit. The user device can notify the user that there is an excessive angle between the camera and the shelf unit using a user interface visualization.

Further details related to homography can be found in “Luo, Yinhui, et al. ‘A review of homography estimation: Advances and challenges.’ Electronics 12.24 (2023): 4977,” which is incorporated herein for all purposes.

### E. Keyframes

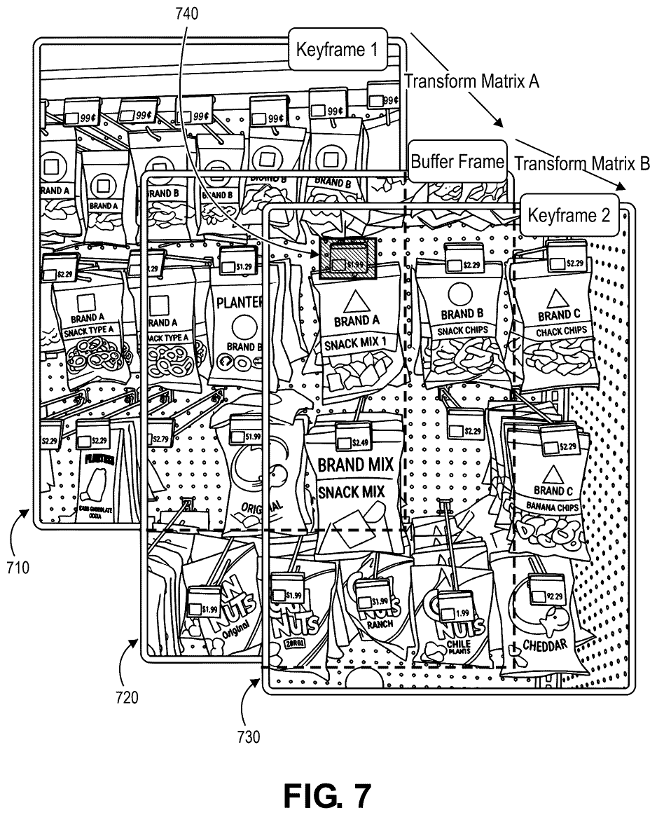

FIG. 7 shows a diagram illustrating keyframes according to embodiments. FIG. 7 illustrates how image transforms can be utilized to uniquely identify shelf item tags in real time. FIG. 7 includes a first keyframe 710 (which may be an example of a first image), a buffer frame 720, and a second keyframe 730 (which may be an example of a second image).

The first keyframe 710 can be an image in an image sequence processed by the user device. The first keyframe 710 can include a machine readable code 740. The user device can detect the machine readable code 740 (e.g., a barcode, QR code, etc.) during the shelf tag detection queue 530. After detecting the machine readable code 740, the user device can capture a high resolution image as the keyframe during the keyframe detection queue 540, which can result in the first keyframe 710. The user device can store the first keyframe 710.

The buffer frame 720 can be an image in the image sequence processed by the user device, but may not trigger the keyframe detection queue 540. The buffer frame 720 can be associated with a transform matrix A that indicates the positional transformation from the first keyframe 710 to the buffer frame 720.

The second keyframe 730 can be an image in the image sequence processed by the user device. The second keyframe 730 can also include the machine readable code 740. The user device can detect the machine readable code 740 as well as a number of other machine readable codes in the second keyframe 730 during the shelf tag detection queue 530. After detecting the machine readable code 740, the user device can capture a high resolution image as the keyframe during the keyframe detection queue 540, which can result in the second keyframe 730. The user device can store the second keyframe 730. The second keyframe 730 can be associated with a transform matrix B that indicates the positional transformation from the buffer frame 720 to the second keyframe 730.

The user device can compare the machine readable code 740 as captured in the second keyframe 730 to the machine readable code 740 as captured in the first keyframe 710 to determine whether or not the machine readable code 740 in each image is the same machine readable code. The user device can utilize the transform matrices (e.g., the transform matrix A and the transform matrix B) to determine whether or not the machine readable codes are in a same or similar location in 3D space.

For example, the user device can multiply the transform matrix A and the transform matrix B to determine the transformation from the first keyframe 710 to the second keyframe 730 to form an overall image transform matrix. The user device can then compare the position of the machine readable code 740 in the first keyframe 710 to the position of the machine readable code 740 in the second keyframe 730 using the relative position of the machine readable code 740 in the image modified by the overall image transform matrix. The user device can compare the relative position of the machine readable code in each image to a threshold distance to determine if the machine readable codes are the same machine readable code.

In some embodiments, the user device can log additional metadata, such as an image transform, which can be 3×3 transform matrix from the first image and can include a list of integers.

### IV. Inventory Update

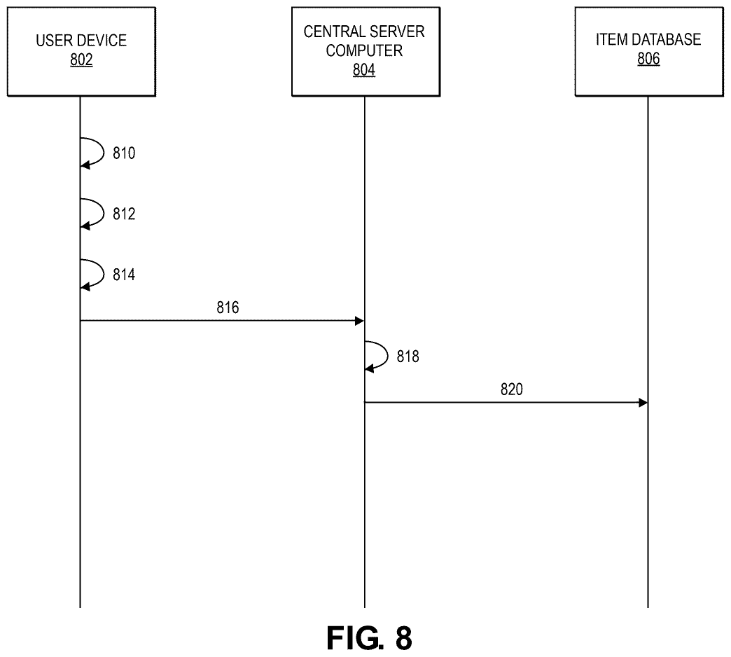

FIG. 8 shows a flowchart illustrating an inventory update method according to embodiments. FIG. 8 will be described in the context of a user, such as a retail associate or inventory auditor, utilizing a user device 802 to perform a data capture session at a service provider location, such as a retail store or warehouse. The captured data can then be transmitted to a central server computer 804 for processing and updating an item database 806.

At step 810, the user device 802 can capture a high-resolution image (e.g., a keyframe). The high-resolution image can contain machine readable codes on a shelf unit (e.g., barcodes on item tags on a shelf). The user device 802 can capture the high-resolution image as described herein.

At step 812, after capturing the high-resolution image, the user device 802 can evaluate each machine readable code in the high-resolution image. The user device 802 can determine an item identifier from each machine readable code. For example, the high-resolution image can include a first machine readable code that is a barcode. The user device 802 can decode the barcode to determine an item identifier for an item associated with the barcode. The item identifier can be a stock keeping unit, a unique identification number, a global trade item number (GTIN), a universal product code (UPC), or other alphanumeric value that represents an item.

At step 814, after obtaining one or more item identifiers, the user device 802 can generate an inventory update message. The inventory update message can include the one or more item identifiers. The inventory update message can also include a location, a location identifier (e.g., a service provider location identifier such as a store number), a time, a date, an item scanning session identifier, a user identifier, and/or a user device identifier. In some embodiments, the inventory update message can include the image used to determine the one or more item identifiers (e.g., the high-resolution image).

In some embodiments, the user device 802 can determine item identifiers from a plurality of high-resolution images and can generate the inventory update message based on the plurality of high-resolution images. As such, the user device 802 can generate the inventory update message based on a batch of high-resolution images and item identifiers.

At step 816, after generating the inventory update message, the user device 802 can provide the inventory update message to the central server computer 804.

At step 818, after receiving the inventory update message, the central server computer 804 can determine item data, from the item database 806, for each item identifier of the inventory update message to obtain one or more item data. The item data can include information related to the item identifier. For example, the central server computer 804 can parse the inventory update message to extract the list of item identifiers. For each item identifier, the central server computer 804 can execute a query against the item database 806 to retrieve the corresponding item record. The retrieved item data can include fields such as an item description, a current inventory count, pricing information, a last-scanned timestamp, service provider details, and a previously recorded location.

At step 820, the central server computer 804 can update the one or more item data in an item database 806. For example, the central server computer 804 can modify the records in the item database 806 based on the information contained in the inventory update message. The update can include changing an inventory status field to reflect that the item was physically present at the specified location. The central server computer 804 can also update a last-scanned timestamp field for each item with the time and date from the inventory update message. Furthermore, the location identifier from the message can be used to confirm or update the recorded location of the item. This process ensures that the central item database 806 serves as an accurate, up-to-date system of record reflecting the ground-truth data captured by the user device 802.

### V. Fulfillment

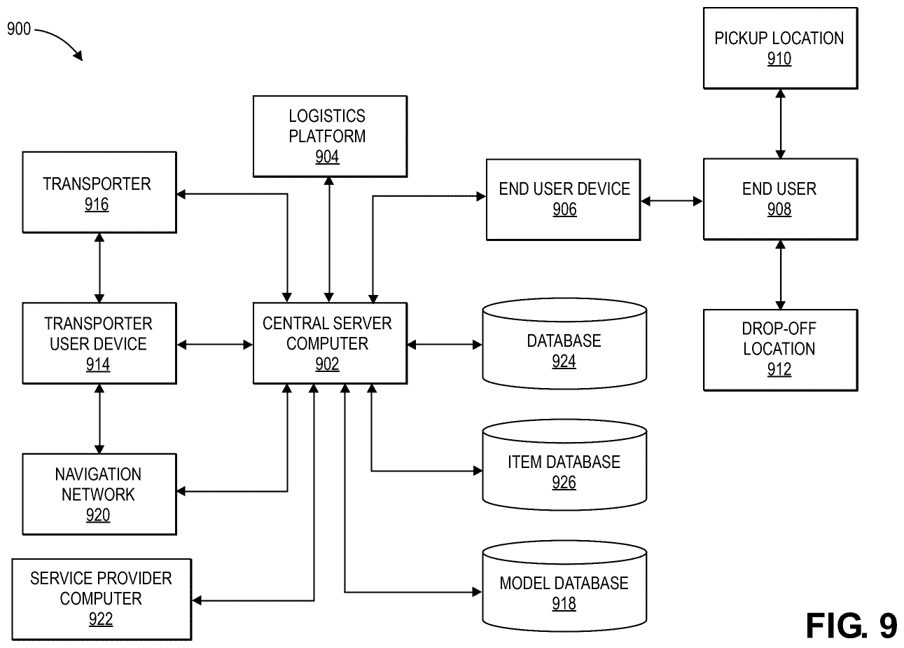

FIG. 9 shows a system 900 according to embodiments of the disclosure. The system of FIG. 9 includes a central server computer 902, a logistics platform 904, an end user device 906, an end user 908, a pickup location 910, a drop-off location 912, a transporter user device 914, a transporter 916, a model database 918, a navigation network 920, a service provider computer 922, a fulfillment database 924, and an item database 926.

The central server computer 902 can be in operative communication with the logistics platform 904, the end user device 906, the transporter user device 914, the navigation network 920, the service provider computer 922, the fulfillment database 924, and the model database 918, and the item database 926. The transporter user device 914 can be in operative communication with the navigation network 920.

For simplicity of illustration, a certain number of components are shown in FIG. 9. It is understood, however, that embodiments of the invention may include more than one of each component. In addition, some embodiments of the invention may include fewer than or greater than all of the components shown in FIG. 9. For example, although FIG. 9 shows one transporter, there can be two, three, or more transporters, transporter user devices, etc.

Messages between the devices and the computers in the system 900 in FIG. 9 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583), and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session. It is understood that other communication means can be utilized by devices in the system 900.

The central server computer 902 can include a server computer that can facilitate in the fulfillment of fulfillment requests received from the end user device 906. For example, the central server computer 902 can identify the transporter 916 (e.g., from among many candidate transporters) operating the transporter user device 914 as being suitable for satisfying the fulfillment request. The central server computer 902 can identify the transporter user device 914 that can satisfy the fulfillment request based on any suitable criteria (e.g., transporter location, service provider location, end user destination, end user location, transporter mode of transportation, etc.).

The central server computer 902 can receive data relating to a delivery order of items from the service provider computer 922 to the end user 908 at the drop-off location 912. The central server computer 902 can determine a route for delivery of the delivery order. The central server computer 902 can present the routes to a plurality of transporter user devices and/or transporters. The central server computer 902 can receive an acceptance (e.g., an acceptance message) from the transporter 916 that will deliver the items from the pickup location 910 to the drop-off location 912.

The central server computer 902 can receive images from user devices that include the end user device 906 and the transporter user device 914. The central server computer 902 can store the images into an image database.

The logistics platform 904 can include a location determination system, which can determine the locations of various user devices such as the transporter user device 914 and the end user device 906. The logistics platform 904 can also include routing logic to efficiently route transporters using the transport user devices to various pickup locations that have the packages that are to be delivered to drop-off locations. Efficient routes can be determined based on the locations of the transporters, the locations of the pickup locations, the locations of the drop-off locations, as well as external data such as traffic patterns, the weather, etc. The logistics platform 904 can be part of the central server computer 902 or can be system that is separate from the central server computer 902.

The end user device 906 can include devices operated by the end user 908. The end user device 906 can generate and provide fulfillment request messages to the central server computer 902. The fulfillment request message can indicate that the request (e.g., a request for a service) can be fulfilled by one or more service provider computers (e.g., the service provider computer 922). For example, the fulfillment request message can be generated based on a cart selected at checkout during a transaction using a central server computer application installed on the end user device 906. The fulfillment request message can include one or more items from the selected cart.

The end user device 906 can provide a fulfillment request message to the central server computer 902 that indicates that the end user device 906 is requesting that the transporter 916 pick up an item from the pickup location 910 (e.g., a service provider of the service provider computer's location) and deliver the item to the drop-off location 912 (e.g., the end user's location).

The pickup location 910 can include locations in which items are stored. In the context of an inbound delivery to an end user, the pickup location can be a service provider location. In the context of an outbound delivery from an end user at an end user location, examples of the pickup location 910 may be a house or an apartment, a mailbox, a service provider location (e.g., a retail store, a grocery store, a dry cleaning store), a pickup hub, etc. Items can first be obtained from the pickup location 910 and then be transported to the drop-off location 912. Examples of the drop-off location 912 can be similar to the pickup location 910, such as a house or an apartment, a mailbox, a retail store, a grocery store, a dry cleaning store, a pickup hub, etc. In one example, a pickup location can be a pizza parlor from which an end user orders a pizza. A drop-off location can be an apartment in which the end user resides.

The transporter user device 914 can include a device operated by the transporter 916. The transporter user device 914 can include a smartphone, a wearable device, a personal assistant device, a laptop computer, etc. The transporter 916 can accept an end user's fulfillment request via an acceptance message. For example, the transporter user device 914 can be configured to generate and transmit a request to fulfil a particular end user's fulfillment request to the central server computer 902. The central server computer 902 can notify the transporter user device 914 of the fulfillment request. The transporter user device 914 can respond to the central server computer 902 with a request to perform the delivery to the end user device 906 as indicated by the fulfillment request.

In some embodiments, the transporter 916 can be an operator of a vehicle. In other embodiments, the transporter 916 can be a vehicle that can operated by an operator or can be autonomous. The vehicle can include a car, a truck, a van, a motorcycle, a bicycle, a drone, or other vehicle.

The navigation network 920 can provide navigational directions to the transporter user device 914. For example, the transporter user device 914 can obtain a location from the central server computer 902. The location can be a service provider parking location, a service provider location, an end user parking location, an end user location, etc. The navigation network 920 can provide navigational data to the location. For example, the navigation network 920 can be a global positioning system that provides location data to the transporter user device.

The service provider computer 922 can include computers operated by service providers. For example, the service provider computer 922 can be a food provider computer that is operated by a food provider. The service provider computer 922 can offer to provide services to the end user 908 of the end user device 906. In some embodiments, the service provider computer 922 can receive requests to prepare one or more items for delivery from the central server computer 902. The service provider computer 922 can initiate the preparation of the one or more items that are to be delivered to the end user 908 of the end user device 906 by the transporter 916 of the transporter user device 914.

The fulfillment database 924 can include any suitable database. The database may be a conventional, fault tolerant, relational, scalable, secure database such as those commercially available from Oracle™ or Sybase™. The fulfillment database 924 can store location data (e.g., a location that includes a latitude and longitude, etc.) and time data (e.g., a specific time).

The model database 918 can similarly be a conventional, fault tolerant, relational, scalable, secure database. The model database 918 can store machine learning models. The model database 918 can store machine learning models.

The item database 926 can similarly be a conventional, fault tolerant, relational, scalable, secure database. The item database 926 can store item data. The item database 926 can store item data for a plurality of items that are provided by service providers to end users via transporters. The item data can include item names, item descriptions, item images, item costs, item weights, item quantities, item categories, and/or any other data related to the creation of the item, the intrinsic properties of the item, and/or the process of providing the item to an end user.

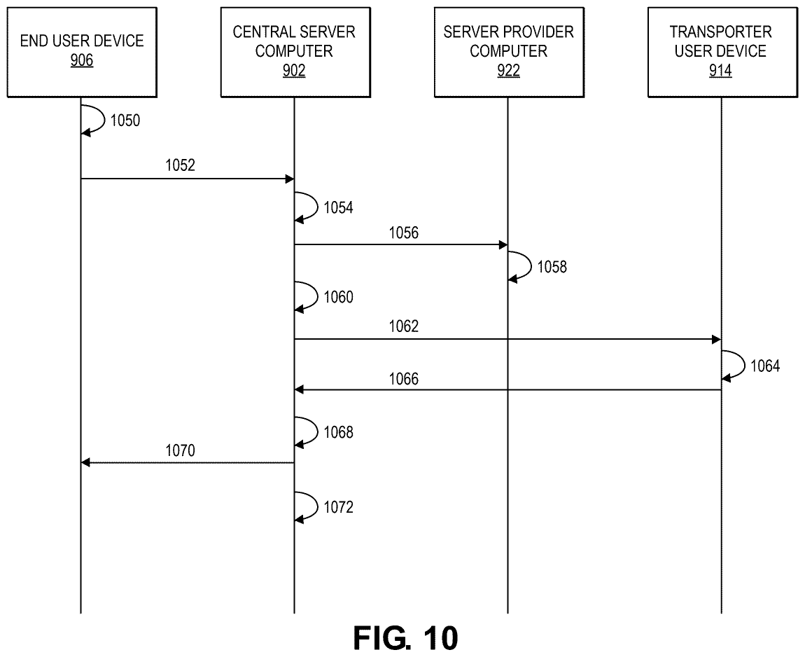

FIG. 10 shows a flow diagram illustrating a preparation and delivery method of an item according to embodiments. The method illustrated in FIG. 10 will be described in the context of the central server computer 902 receiving a fulfillment request message from the end user device 906 to fulfill preparation and delivery of one or more items from a cart to an end user of the end user device 906. The central server computer 902 can communicate with the service provider computer 922 and the transporter user device 914 to fulfill the fulfillment request.

At step 1050, the end user device 906 can decide to check out with a cart in a central server computer delivery application installed on the end user device 906. The cart can include one or more items that are provided from a service provider of the service provider computer 922.

At step 1052, after checking out with the cart, the end user device 906 can provide a fulfillment request message including the one or more items from the cart to the central server computer 902. The fulfillment request message can also include a service provider computer identifier that identifies the service provider computer 922.

At step 1054, after receiving the fulfillment request message, the central server computer 902 can perform a transaction process with the end user device 906. For example, the central server computer 902 can communicate with a payment network to process the transaction for the one or more items. The central server computer 902 can receive an indication of whether or not the transaction is authorized. If the transaction is authorized, then the central server computer 902 can proceed with step 1008.

At step 1056, the central server computer 902 can provide the fulfillment request message, or a derivation thereof, to the service provider computer 922. The central server computer 902 can determine which service provider computer of a plurality of service provider computers to communicate with based on the service provider indicated in the fulfillment request message. For example, the fulfillment request message can indicate that the one or more items are provided by the service provider of the service provider computer 922. The central server computer 902 can identify the service provider computer 922 using the service provider computer identifier in the fulfillment request message.

At step 1058, after receiving the fulfillment request message, the service provider computer 922 can initiate preparation of the one or more items. For example, the service provider computer 922 can alert service provider personnel (e.g., those preparing the items) at the service provider location. The service providers can prepare the one or more items for pick up by a transporter.

At step 1060, after providing the fulfillment request message to the service provider computer 922, the central server computer 902 can determine one or more transporters operating one or more user devices that are capable of fulfilling the fulfillment request message. The central server computer 902 can determine the one or more transporters from the transporter user devices. The central server computer 902 can determine the one or more transporter user devices based on whether or not the transporter user device is online, whether or not the transporter user device 914 is already fulfilling a different fulfillment request message, a location of the transporter user device 914, etc.

At step 1062, after determining the one or more transporter user devices, the central server computer 902 can provide the fulfillment request message, or a derivation thereof, to the one or more transporter user devices including the transporter user device 914.

At step 1064, after receiving the fulfillment request message, the transporter of the transporter user device 914 can determine whether or not they want to perform the fulfillment. The transporter can decide that they want to perform the delivery of the one or more items from the service provider location to the end user location. The transporter user device 914 can generate an acceptance message that indicates that the fulfillment request is accepted.

At step 1066, after generating the acceptance message, the transporter user device 914 can provide the acceptance message to the central server computer 902.

After providing the acceptance message to the central server computer 902, the transporter user device 914 can communicate with a navigation network and the transporter can proceed to the service provider location to obtain the one or more items. The transporter user device 914 can then receive input from the transporter that indicates that the transporter obtained the one or more items (e.g., the transporter selects that they picked up the items). The transporter user device 914 can then communicate with the navigation network and the transporter can then proceed to the end user location to provide the one or more items to the end user. In some embodiments, the transporter user device 914 can provide update messages to the central server computer 902 that includes a transporter user device 914 location and/or event data (e.g., items picked up, items delivered, etc.).

In some embodiments, after receiving the acceptance message, the central server computer 902 can notify the other transporter user devices that received the fulfillment request message that the fulfillment request is no longer available.

At step 1068, at any point after receiving the acceptance message, the central server computer 902 can check the status of the fulfillment request. For example, the central server computer 902 can determine the location of the transporter user device 914 and can determine an estimated amount of time for the transporter user device 914 to arrive at the end user location.

At step 1070, the central server computer 902 can provide an update message to the end user device 906 that includes data related to the fulfillment of the fulfillment request message. The data can include an estimated amount of time, the transporter user device location, event data (e.g., items picked up from the service provider), and/or other data related to the fulfillment of the fulfillment request message.

At step 1072, the central server computer 902 can store any data received, sent, and/or processed during the fulfillment of the fulfillment request message into a database. For example, the central server computer 902 can store a user's cart selection as user features into a user feature database.

In some embodiments, the end user may search for a particular item using a search bar. In such cases, the central server computer 902 can use image filtering to surface contextualized images on the search feed that includes the item related to what an end user has searched. By providing the image related to what the user has searched, the user does not have to search through an entire menu to look for an item. For example, in FIG. 10, when a user searches for a “burger”, images related to the word “burger” for service providers are displayed in a screen.

In some embodiments, the plurality of images can be images of the plurality of service providers, and the inquiry request can be with respect to determining a service provider of the plurality of service providers. For example, an image can be an image of an item that can be provided by the service provider to the end user via the transporter.

For example, the central server computer can determine which service providers are displayed on the homepage. The homepage of the delivery application can have a plurality of “slots” that each can display a service provider. For each slot on the homepage, the central server computer can use a scoring algorithm to determine a service provider of the plurality of service providers to display in the delivery application.

### VI. Advantages

Embodiments of the disclosure have a number of technical advantages. Embodiments provide for an augmented reality system that can display scanning instructions to a user of a user device in real time as they capture images of shelf units. The scanning instructions can be updated as the user device captures images. The scanning instructions can indicate to the user where to point a camera in the user device and at what orientation the user device should be placed. The scanning instructions are not fixed instructions, but are dynamically updated in real time based on the images captured by the user device.

The invention offers technical advantages over conventional scanning methods by providing a technically improved, guided, and automated workflow. The multi-process architecture allows the system to deliver a highly responsive and fluid user experience while performing complex image processing tasks in the background. The high-priority visualization queue can provide immediate feedback to the user, showing a live overlay of scanned areas and highlighting undetected items, which can effectively guide the user and prevent missed or overlapping scans. This architecture directly addresses the problem of poor machine readable code detection by intelligently capturing high-resolution keyframes only when the camera is determined to be steady and correctly positioned, thereby improving the quality of the source images for machine readable code processing.

Furthermore, the system can enhance efficiency by automating the capture process. Rather than requiring the user to manually trigger each photo, the user device can automatically capture keyframes when the user device detects new, unscanned items within its view, reducing the cognitive load on the user and speeding up the overall process. The ability to compute frame-to-frame transforms allows the system to understand the spatial relationship between images, enabling it to merge data from multiple frames and uniquely identify each shelf tag in real time. This creates a more accurate and comprehensive map of the scanned environment. The system's design can also allow for a session to be recovered if tracking can be lost, providing a more robust and reliable tool for operators in the field.

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
displaying, by a user device, a prompt to capture an image sequence of a shelf unit with items and item tags comprising machine readable codes adjacent to the items, wherein the image sequence includes a plurality of images;
capturing, by the user device, a first image using a camera in the user device;
generating, by the user device, a first user interface visualization that indicates first scanning instructions for the first image of the image sequence based on a previous image of the image sequence, the scanning instructions for the first image being instructions to move the user device to take a second image of the image sequence;
displaying, by the user device, the first user interface visualization and the first image;
capturing, by the user device, the second image;
generating, by the user device, a second user interface visualization that indicates second scanning instructions for the second image, the scanning instructions for the second image being instructions to move the user device to take a third image of the image sequence; and
displaying, by the user device, the second user interface visualization and the second image.

2. The method of claim 1, wherein the method further comprises:
identifying, by the user device, one or more current item tags in the second image; and
comparing, by the user device, the one or more current item tags to one or more previous item tags from one or more previous images of the image sequence, and wherein the second user interface visualization includes indications of the one or more item tags.

3. The method of claim 2, further comprising:
labeling, by the user device, the one or more current item tags with item tag identifiers based on the one or more previous item tags.

4. The method of claim 2, further comprising:
detecting, by the user device, a new item tag in the one or more current item tags that is not included in the one or more previous item tags;
determining, by the user device, if a threshold number of new item tags are in the second image; and
if the threshold number of new item tags are in the second image, capturing a higher resolution image that includes the new item tags.

5. The method of claim 4, further comprising:
in response to capturing the higher resolution image, executing, by the user device, a background process to decode the machine readable codes contained within the new item tags.

6. The method of claim 4, further comprising:
detecting, by the user device, that a camera plane of the camera in the user device is parallel to a shelf unit plane.

7. The method of claim 1, wherein generating the first user interface visualization comprises:
determining, by the user device, a transform that indicates a spatial relationship between the first image and the previous image.

8. The method of claim 2, wherein the indications of the one or more item tags in the second user interface visualization include color-coded labels indicating a processing status for each of the one or more item tags.

9. The method of claim 1, wherein the first scanning instructions are further based on an orientation of the user device, wherein the method further comprises:
monitoring, by the user device, the orientation of the user device, wherein the orientation comprises a pitch, a yaw, and a roll.

10. The method of claim 1, further comprising:
determining, by the user device, one or more item identifiers using the one or more current item tags in the second image;
generating, by the user device, an inventory update message comprising the one or more item identifiers; and
providing, by the user device, the inventory update message to a central server computer.

11. The method of claim 10, wherein the inventory update message further comprises the second image.

12. A user device comprising:
a processor; and
a computer-readable medium coupled to the processor, the computer-readable medium comprising code, executable by the processor, for implementing a method comprising:
displaying a prompt to capture an image sequence of a shelf unit with items and item tags comprising machine readable codes adjacent to the items, wherein the image sequence includes a plurality of images;
capturing a first image using a camera in the user device;
generating a first user interface visualization that indicates first scanning instructions for the first image of the image sequence based on a previous image of the image sequence, the scanning instructions for the first image being instructions to move the user device to take a second image of the image sequence;
displaying the first user interface visualization and the first image;
capturing the second image;
generating a second user interface visualization that indicates second scanning instructions for the second image, wherein the second user interface visualization includes indications of the one or more item tags; and
displaying the second user interface visualization and the second image.

13. The user device of claim 12, wherein the method further comprises:
identifying one or more current item tags in the second image;
comparing the one or more current item tags to one or more previous item tags from one or more previous images of the image sequence;
detecting a new item tag in the one or more current item tags that is not included in the one or more previous item tags;
determining if a threshold number of new item tags are in the second image; and
if the threshold number of new item tags are in the second image, capturing a higher resolution image that includes the new item tags, wherein the higher resolution image is a keyframe.

14. The user device of claim 13, wherein capturing the higher resolution image comprises:
initiating a keyframe detection queue configured to capture the keyframe, wherein the keyframe detection queue triggers a machine readable code processing queue to evaluate one or more machine readable codes that are included in the keyframe.

15. The user device of claim 12, wherein the user device is a mobile phone.

16. The user device of claim 12, wherein the method further comprises:
determining, by the user device, one or more item identifiers using the one or more current item tags in the second image;
generating, by the user device, an inventory update message comprising the one or more item identifiers from the second image, the second image, additional one or more item identifier from additional images, and the additional images; and
providing, by the user device, the inventory update message to a central server computer.

17. The user device of claim 12, wherein the shelf unit with items and item tags comprising machine readable codes adjacent to the items is located at a service provider location operated by a service provider that provides the items to end users, wherein the items include food items.

18. A method comprising:
receiving, by a server computer from a user device, an inventory update message from the user device, wherein the inventory update message comprises one or more item identifiers, wherein the one or more item identifiers are determined by the user device from one or more images captured by the user device using one or more user interface visualizations to aid in image capture;
determining, by the server computer from a database, item data each item identifier of the one or more item identifiers to obtain one or more item data; and
updating, by the server computer, the one or more item data in an item database.

19. The method of claim 18, wherein the inventory update message further comprises the one or more images captured by the user device.

20. The method of claim 18, wherein the user device displays a prompt to capture an image sequence of a shelf unit with items and item tags comprising machine readable codes adjacent to the items, wherein the image sequence includes a plurality of images, generates a first user interface visualization that indicates first scanning instructions for a first image of the image sequence based on a previous image of the image sequence, displays the first user interface visualization and the first image, captures a second image, identifies one or more current item tags in the second image, compares the one or more current item tags to one or more previous item tags from one or more previous images of the image sequence, generates a second user interface visualization that indicates second scanning instructions for the second image, wherein the second user interface visualization includes indications of the one or more item tags, and displays the second user interface visualization and the second image.
